(19) United States
(12) Patent Application Publication
(10) Pub. No.: US 2005/0209098 A1
(43) Pub. Date: Sep. 22, 2005

(54) Carbon supported metal alloy catalysts and method for the manufacturing thereof

(75) Inventors: Andrea F. Gulla, Malden, MA (US); Robert J. Allen, South Harwich, MA (US)

Correspondence Address: HEDMAN & COSTIGAN P.C., 1185 AVENUE OF THE AMERICAS, NEW YORK, NY, 10036, US

(73) Assignee: DE NORA ELETTRODI S.p.A.

(21) Appl. No.: 11/071,011

(22) Filed: Mar. 3, 2005

Related U.S. Application Data
(60) Provisional application No. 60/554,836, filed on Mar. 19, 2004.

(51) Int. Cl. B01J 21/18

(52) U.S. Cl. 502/182; 502/184; 502/185

(57) ABSTRACT

A carbon supported metal alloy catalyst obtained by first depositing a noble metal on a carbon support and subsequently selectively depositing at least one second metal on the thus-obtained carbon-supported noble metal in an aqueous environment, wherein said selective deposition is obtained by reduction of a precursor of said second metal with hydrogen gas, said reduction being catalyzed by said noble metal and localized in correspondence thereto and a method for its production.

### PRIOR APPLICATION

This application is a non-provisional application of U.S. Provisional Application Ser. No. 60/554,836 filed Mar. 19, 2004.

### FIELD OF THE INVENTION

The invention is relative to a catalyst, in particular to a carbon supported electrocatalyst suitable for incorporation in a gas diffusion electrode structure.

### BACKGROUND OF THE INVENTION

The use of gas-diffusion electrodes activated with carbon-supported electrocatalysts is well known in several electrochemical processes, especially in the field of depolarized electrolysis processes making use either of hydrogen-consuming anodes or of oxygen-consuming cathodes, and in fuel cell applications. Platinum supported on carbon black is by far the most widespread of catalysts for low and medium temperature fuel cell technologies based on gas-diffusion electrodes, such as phosphoric acid fuel cells (PAFC), proton exchange membrane fuel cells (PEMFC) and direct methanol fuel cells (DMFC). Nevertheless, the supported catalysts based on platinum alone are known to have insufficient activity in certain common environments, especially anodic environments in which poisonous species such as carbon monoxide (CO) are present.

To mention just the important cases, free CO is present as a typical impurity in the anode feed of PEMFCs supplied with hydrogen coming from the steam reforming or partial oxidation of hydrocarbons or alcohols, and it also forms as an intermediate species in methanol electro-oxidation, which is the reaction taking place at the anode of a DMFC. It is, however, known in the art that the catalytic activity of platinum-based catalysts can be enhanced in these cases by alloying platinum with at least one second metal capable of counteracting at least in part the poisoning effect of the CO molecule. Pt—Ru (see for instance U.S. Pat. No. 4,294,608 and EP 952,241), PT-Mo (U.S. Pat. No. 6,379,834) and Pt—Zn (EP 899,348) alloys are just some examples of established CO-tolerant alloys, and ternary or quaternary formulations including more than one metal other than platinum have also been extensively disclosed (se for instance GB 2,095,025, U.S. Pat. No. 5,489,563 and U.S. Pat. No. 6,517,965). Platinum or other noble metal-based alloys are also applied for enhancing the oxygen reduction in oxygen-consuming cathodes for fuel cells and electrolyzers (such as Pt—Ag used in oxygen-depolarized chloralkali electrolysis and Pt—Rh used in hydrochloric acid electrolysis), or for achieving catalysts particularly tolerant to accidental cell polarity reversals.

However, in most of the cases, these alloys are not easy to obtain, at least in a quantitative fashion. For Pt—Ru alloys, several wet chemistry preparations have been disclosed involving successive precipitation or co-precipitation from precursors such as H₂PtCl₆ and RuCl₃, making use of strong reductants such as hydrazine or formaldehyde. This type of preparation almost always gives rise to poorly alloyed solid solutions of the two metals, due to the fact that the lattice parameters of the elements involved and the rate of conversion of the relevant precursors are too different.

In most of the cases, an XRD scan shows the characteristic peaks of the two original metal phases, with a limited formation of a third phase indicating some partial alloying. Also, the most common Pd, Rh and Ir alloys are known to follow the same fate. Although some optimization of the experimental parameters may lead to the maximization of the required alloy, non site-specific precipitation of metals from two distinct precursors always gives rise, to some extent, to an undesired mutual segregation of the components.

Furthermore, the common chemical reductants of the prior art are to some extent toxic, and must be, in any case, removed from the highly porous carbon support in which they are easily absorbed. Careful washing of the final products must therefore be carried out, and non-negligible volumes of water containing toxic species must eventually be treated. Also, manufacturing methods of the prior art different from wet chemistry precipitation, such as chemical or physical vapor deposition (see for instance WO 02/098561) tend to form solid solutions with only some degree of alloying, beside being quite more expensive. There is, therefore, the need for a simple, cheap and effective way to produce carbon-supported metal alloy catalysts overcoming the drawbacks of the prior art.

### OBJECTS OF THE INVENTION

It is an object of the invention to provide carbon-supported metal alloy catalysts by site-specific catalyzed deposition of a second metal on a carbon-supported noble metal.

It is another object of the invention to provide carbon-supported metal alloy catalysts starting from a carbon-supported noble metal catalyst and catalytically depositing a second metal thereon by reduction of a suitable precursor with hydrogen gas.

It is a further object of the invention to provide a gas-diffusion electrode comprising a carbon-supported metal alloy catalyst obtained via site-specific reduction of a second metal on a carbon-supported noble metal.

These and other objects and advantages of the invention will become obvious from the following detailed description, wherein some preferred, non-limiting embodiments of the invention are disclosed for a merely exemplifying purpose.

### THE INVENTION

In a first aspect, the invention consists of a carbon-supported metal alloy catalyst obtained by first supporting a noble metal on a carbon support by means of any of the several methods known in the art, and subsequently carrying out a selective deposition of a second metal from a suitable precursor by catalytically reducing the same with hydrogen gas. By catalyzed reduction with hydrogen, it is intended that the noble metal and the precursor of a second metal are carefully selected so that hydrogen gas would not be capable of reducing the precursor of the second metal in the absence of the noble metal due to kinetic limitations in the selected reaction conditions, and that the reduction takes place only in correspondence of the carbon-supported noble metal particles acting as a catalyst capable of overcoming such kinetic limitations. In this way, the reduction of the second metal precursor is site-specific, and a very high degree of alloying is obtained. Furthermore, a very clean reactant such as hydrogen gas is employed as the reductant, leaving no residues on the catalyst after the preparation.

By carbon-supported metal alloy catalyst, it is intended a catalyst consisting of an alloy of two or more zerovalent metals (i.e. metals in their elementary state) finely deposited on a carbon particle, preferably a high surface area, electrically conductive carbon. By high surface area carbon, it is intended a carbon particle with an active area not lower than 50 m²/g and in a preferred embodiment, an electrically conductive carbon black particle with an active area of at least 50 m²/g is selected as the support, but also other carbon supports such as graphite particles are suited to the scope. The site-specific catalyzed reduction with hydrogen is preferably carried out at room temperature, also for the sake of simplicity, easy scalability and energy saving. For this reason, in a preferred embodiment, the carbon-supported noble metal is selected from the group of platinum, rhodium, iridium and palladium, which are particularly active in catalyzing the localized reduction of a number of other useful metals with hydrogen at room temperature.

Among the second metals that can be catalytically reduced on carbon-supported noble metal particles under these conditions, particularly preferred are ruthenium, silver, copper, rhenium but also platinum, iridium, rhodium and palladium themselves. The precursor of the second metal to be catalytically reduced is preferably a soluble salt (for instance a chloride, nitrate or sulfate), or a soluble oxide (e.g. cuprous oxide) or a complex species.

In a second aspect, the invention consists of a gas-diffusion electrode for electrochemical processes comprising a carbon-supported metal alloy catalyst as hereinbefore described, deposited on a gas permeable electrically conductive web such as a carbon paper or carbon woven or non-woven cloth.

In a further aspect, the invention consists of a method for producing a carbon-supported metal alloy catalyst as hereinbefore described, comprising the steps of preparing a carbon-supported noble metal catalyst and of depositing at least one second metal thereon by selectively reducing a precursor of the second metal with hydrogen gas in an aqueous solution, preferably at room temperature. In a preferred embodiment, the noble metal is platinum, rhodium, iridium or palladium supported on an electrically conductive carbon black, more preferably having an active area not lower than 50 m²/g.

In a preferred embodiment, the starting carbon-supported noble metal catalyst is a commercially available catalyst, which is dispersed in an aqueous solution and then used to catalyze the selective reduction of the second metal precursor with hydrogen gas. In a preferred embodiment, the catalyzed reduction of the second metal precursor is controlled by monitoring the pH and/or the color change or by a spot-test of the aqueous solution.

In the following examples, there are described several preferred embodiments to illustrate the invention. However, the invention is not intended to be limited to the specific embodiments.

### EXAMPLE 1

Described herein is a method to precipitate a Pt alloy (Pt₃Cu) supported on carbon from an aqueous solution in which gaseous H₂ has been sparged. Precipitation reactions of other Pt based alloys catalysts (PtM, M=rhodium, rhenium, palladium or iridium) only require minor adjustments that can be easily derived by one skilled in the art.

In a 1 liter round bottom flask, 4.00 g of 30% Pt⁰ supported on Vulcan were slurried in 500 ml of deionized water and ultrasonically dispersed for one hour. While vigorously stirring, 0.5234 g of CuSO₄.5H₂O (containing 0.133 g of CU²⁺ equal to 0.0021 moles) were added to the solution. H₂ was sparged into the solution at a pressure of 30 psig. Meanwhile, the reaction beaker was constantly monitored for temperature, Cu⁺² concentration and pH of the solution. The pH never exceeded 5.00 (at the beginning of the reaction) and it never went below 3.00 (at the completion of the reaction).

After one hour of sparging H₂ into the solution at room temperature, a sudden color change for the Cu-ferrocyanate spot test was observed. The initial red/brown color (characteristic of Cu ferrocyanide), progressively changed to light red as the reaction progressed, and finally turned colorless upon completion of the reaction, thus indicating a total reduction of the metal on the carbon. The precipitate was allowed to settle and then was vacuum filtered. The filtrate was washed with 1000 ml of deionized water and the filter cake was collected and air dried at 100° C. overnight.

The resulting carbon-supported catalyst was characterized by X-ray crystallography which indicated a shift of the main phase (111) position Pt, thus confirming that the material was indeed comprised of a Pt₃Cu alloy supported on carbon.

### EXAMPLE 2

In the following, there is described a preferred embodiment for the preparation of a Pt₃Ag alloy supported on carbon. In a 1 liter round bottom flask, 4.00 g of 30% Pt supported on Vulcan carbon black were slurried in 500 ml of deionized water and ultrasonically dispersed for one hour. While vigorously stirring, 0.350 g of AgNO₃ (containing 0.220 g of Ag⁺ equal to 0.0020 moles) were added to the solution and H₂ was sparged into the solution at a pressure of 30 psig. Meanwhile, the reaction beaker was constantly monitored for temperature, Ag⁺ concentration and pH of the solution. The pH never exceeded 2.47 (at the beginning of the reaction) and it never went below 2.15 (at the completion of the reaction).

After one hour of sparging H₂ into the solution at room temperature, a change of the Ag⁺ concentration in the solution was observed by a spot test with Cl⁻ ions. The initial white precipitate (characteristic of AgCl), progressively changed to a light white haze as the reaction progressed, and finally turned colorless upon completion of the reaction, thus indicating a total reduction of the metal on the carbon. The precipitate was allowed to settle and then was vacuum filtered. The filtrate was washed with 1000 ml of deionized water and the filter cake was collected and air dried at 100° C. overnight.

The resulting carbon-supported catalyst was characterized by X-ray crystallography which indicated a shift of the main phase (111) position Pt thus confirming that the material was indeed comprised of a Pt₃Ag alloy supported on carbon.

### EXAMPLE 3

In the following, there is described a preferred embodiment for the preparation of a Pt₃Ru alloy supported on carbon. In a 1 liter round bottom flask, 3.80 g of 30% Pt supported on Vulcan were slurried in 500 ml of deionized water and ultrasonically dispersed for one hour. While vigorously stirring, 0.509 g of RuCl₃.H₂O (containing 0.197 g of Ru⁺³ equal to 0.0019 moles) were added to the solution and H₂ was sparged into the solution at a pressure of 30 psig. Meanwhile, the reaction beaker was constantly monitored for temperature and color. The pH never exceeded 2.3 (during the reaction) and it never went below 1.95 (at the beginning of the reaction).

After one hour of sparging H₂ into the solution at room temperature, a change in the color of the solution was observed as followed by spot test. The initial medium tan color of the solution (characteristic of RuCl₃.3H₂O) progressively turned to colorless upon completion of the reaction, thus indicating a total reduction of the metal on the carbon. The precipitate was allowed to settle, and then was vacuum filtered. The filtrate was washed with 1000 ml of deionized water and the filter cake was collected and air dried at 100° C. overnight.

The resulting carbon-supported catalyst was characterized by X-ray crystallography which indicated a shift of the main phase (111) position Pt thus confirming that the material was indeed comprised of a Pt₃Ru alloy supported on carbon.

Various modifications of the catalyst and method of the invention may be made without departing from the spirit or scope thereof and it is to be understood that the invention is to be limited only as defined in the appended claims.

1. A carbon supported metal alloy catalyst obtained by first depositing a noble metal on a carbon support and subsequently selectively depositing at least one second metal on the thus-obtained carbon-supported noble metal in an aqueous environment, wherein said selective deposition is obtained by reduction of a precursor of said second metal with hydrogen gas, said reduction being catalyzed by said noble metal and localized in correspondence thereto.

2. The catalyst of claim 1 wherein said carbon support is a carbon black having an active area of at least 50 m²/g.

3. The catalyst of claim 1 wherein said noble metal is selected from the group consisting of platinum, rhodium, iridium and palladium.

4. The catalyst of claim 3 wherein said catalyzed reduction with hydrogen gas is carried out at room temperature.

5. The catalyst of claim 1 wherein said at least one second metal is selected from the group consisting of silver, copper, ruthenium, rhodium, platinum, palladium, iridium and rhenium.

6. The catalyst of claim 5 wherein said precursor of said second metal is a soluble oxide, salt or complex.

7. A gas diffusion electrode comprising the catalyst of claim 1 deposited on a gas permeable conducting web.

8. A method for producing a carbon supported catalyst comprising first preparing a carbon supported noble metal, and subsequently depositing at least one second metal on said carbon supported noble metal by selectively reducing a precursor of said second metal with hydrogen gas in an aqueous solution.

9. The method of claim 8 wherein said carbon supported noble metal is selected from the group consisting of platinum, rhodium, iridium and palladium supported on a carbon black having an active area of at least 50 m²/g.

10. The method of claim 8 wherein said catalyzed reduction is carried out by dispersing said carbon-supported noble metal in said aqueous solution, adding said second metal precursor while stirring, sparging hydrogen gas into said aqueous solution and allowing the resulting mixture to react until completing the site-specific precipitation of said second metal.
